(19) United States
(12) Patent Application Publication
(10) Pub. No.: US 2023/0374798 A1
(43) Pub. Date: Nov. 23, 2023

(54) MOBILE SCAFFOLD FOR A RACKING SYSTEM AND RACKING SYSTEM COMPRISING A MOBILE SCAFFOLD

(71) Applicant: MONTEL INC., Montmagny (CA)

(72) Inventor: Yves BÉLANGER, Berthier-sur-Mer (CA)

(21) Appl. No.: 18/321,889

(22) Filed: May 23, 2023

Related U.S. Application Data
(60) Provisional application No. 63/344,748, filed on May 23, 2022.

(51) Int. Cl. E04G 1/38; E04G 1/24; E04G 1/34; E04G 1/20; E04G 5/00

(52) U.S. Cl. CPC E04G 1/38; E04G 1/24; E04G 1/34; E04G 1/20; E04G 5/00; E04G 2001/242

(57) ABSTRACT

The racking system comprises at least one rack and a mobile scaffold, the scaffold comprising a frame defining opposite first and second sides, a platform carried by the frame, for supporting a person above ground, a scaffold guide member carried by the frame on the first side, a rack guide member carried by the rack which is complementary to the scaffold guide member, with the scaffold guide member releasably engaging the rack guide member such that the scaffold is retained against the rack and is guided along the rack while allowing the scaffold to be movable along the rack, and a support member carried by the frame for allowing releasable support of the frame by either one of the rack and the ground. The frame is linked to a single rack of the racking system.

### CROSS-REFERENCE TO RELATED APPLICATIONS

This application claims the benefit of U.S. Provisional Application No. 63/344,748 filed on May 23, 2022. The entire disclosure of the above application is incorporated herein by reference.

### FIELD

The present invention relates a mobile scaffold for allowing a user to access upper shelves in racks such as storage racks or interior growing or cultivation racks of a racking system.

### INTRODUCTION

Known racking systems include fixed racking systems where racks are disposed side-by-side with an aisle provided between each two racks, and mobile racking systems that have mobile racks. In both cases the racks each have a frame supporting a number of shelves.

In the mobile racking systems, the racks are carried on ground rails that allow the racks to be displaced along the rails with a driving mechanism. Manual and automatic driving mechanisms exist. The mobile racking systems conventionally allow the mobile racks to be horizontally stacked, i.e., to be positioned adjacent to one another, while freeing a single aisle between two selected racks. This aisle will allow access to a person desiring to recuperate an article stored in the racks that are on either side of the aisle, or to place an article on those racks. To access other racks, the racks can be displaced along the rails to rearrange the horizontal stacking of the racks to create a new aisle, the racks collapsing on the previous aisle to form the new aisle. Consequently, minimal volume is occupied by the mobile rack system since an aisle is not required between each two successively adjacent racks.

To further optimize storage space, racks are often well above human height. To reach the upper shelves to store and retrieve articles, a ladder is often an undesirable solution since it is unstable and may yield injuries to users. It is consequently known to use scaffolds that may temporarily be installed in the aisles. Such scaffolds will include transverse supports that will rest on both racks situated on either side of the aisle, and a platform that in turn rests on those supports. A user may then climb onto the platform to reach the higher shelves on either one of the racks located on either side of the aisle.

These prior art systems comprise several disadvantages.

First, once the scaffold is installed, whenever a user needs to access articles located further down the aisle, or within another aisle, they need to uninstall the scaffold and install it at the new location, which requires reinstalling and securing the supports to both racks on either side in the aisle and at the new location. This is long. Also, transporting and installing the scaffold includes security issues both in manipulation and in storage, due to the heavy equipment that is carried, which leads to unfortunate injuries in the workplace to users.

Also, the prior art systems require racks on either side of the scaffold to be present. If the aisle is instead located between, say, a rack and a wall, or at the end of a racking system where no structure is present beyond the endmost rack, then a support structure needs to be provided specifically for supporting the second side of the scaffold.

Another disadvantage of prior art scaffold systems is that, since they are attached to racks on both sides of the aisle, it forces the racks to have a precise, set spacing between one another to form an aisle having the required width to fit the scaffold therein.

Also, once attached, the scaffold blocks the entire width of the aisle since it is carried by the racks on both sides, preventing passage between the scaffold and the racks.

Furthermore, prior art scaffolds require a dedicated offsite storage area where the scaffold will be stored while it is not in use in an aisle.

### SUMMARY

It is consequently an object of the invention to improve upon prior art scaffolds for racking systems.

More particularly, the present invention relates to a mobile scaffold for a racking system of the type comprising at least one rack, said scaffold comprising:
a frame defining opposite first and second sides;
a platform carried by said frame, for supporting a person above ground;
a scaffold guide member carried by said frame on said first side for allowing releasable engagement of said frame to a complementary rack guide member on the rack such that said frame is retained against said rack, is guided along said rack and is movable along said rack; and
a support member carried by said frame for allowing releasable support of said frame by either one of said rack and the ground;
wherein said frame is linked only to said at least one rack and to no other rack of said racking system.

In one embodiment, said second member comprises a ground-engaging support member carried by said frame for resting on the ground.

In one embodiment, said ground-engaging member comprises ground-engaging wheels that are located on said second side of said frame.

In one embodiment, said scaffold guide member comprises guide wheels for engagement into a rail forming said rack guide member carried by said rack.

In one embodiment, said scaffold guide member further allows the scaffold to be partly supported by said rack, such that said scaffold guide member and said ground-engaging support member share the load of said scaffold.

In one embodiment, said scaffold is movable between an operative position in which said platform is generally horizontal for supporting the person above ground and in which said support member rests on the ground, and a stored position in which said frame and said platform are moved away from said operative position into a compact configuration that occupies less horizontal space than said operative position, and in which said support member is raised above ground such that the load of said scaffold is entirely supported by the rack.

In one embodiment, said platform is pivotally mounted to said frame and is pivotable between said operative and stored positions.

In one embodiment, said frame comprises a height adjustment member for adjusting the height of the platform relative to said rack support member and to said ground-engaging support member.

In one embodiment, said frame further carries a brake that is releasably engageable with either one of the scaffold guide member, the rack guide member and the rack, for releasably fixing the position of said scaffold relative to the rack.

The invention also relates to a racking system comprising at least one rack and a mobile scaffold, said scaffold comprising:
a frame defining opposite first and second sides;
a platform carried by said frame, for supporting a person above ground;
a scaffold guide member carried by said frame on said first side;
a rack guide member carried by said rack which is complementary to said scaffold guide member, with said scaffold guide member releasably engaging said rack guide member such that said scaffold is retained against said rack and is guided along said rack while allowing said scaffold to be movable along said rack; and
a support member carried by said frame for allowing releasable support of said frame by either one of said rack and the ground;
wherein said frame is linked to a single rack of said racking system.

### DRAWINGS

The drawings described herein are for illustrative purposes only of selected embodiments and not all possible implementations and are not intended to limit the scope of the present disclosure.

In the annexed drawings:

FIG. 1 is a perspective view of one rack of a racking system carried on ground-resting rails that are partly shown, together with a mobile scaffold operatively installed on the rack;

FIG. 2 is an end elevation view of the racking system of FIG. 1, further showing a second rack spaced from the first rack such that an aisle is formed between the two racks, with the mobile scaffold being installed on the first rack in the aisle;

FIG. 3 is an enlarged perspective view of the mobile scaffold of FIG. 1, further showing one end of the scaffold rail used to carry the scaffold to suggest how the scaffold may engage the scaffold rail;

FIG. 4 is an enlarged perspective view of the mobile scaffold of FIG. 1 at a different angle compared to FIG. 3, with the scaffold engaging the scaffold rail;

FIG. 5 is similar to FIG. 4, but shows the mobile scaffold platform in a raised position compared to FIG. 4;

FIG. 6 is similar to FIG. 1, but shows the mobile scaffold in its stored position; and

FIG. 7 is an enlarged perspective view of the mobile scaffold of FIG. 6 in its stored position, further showing part of the scaffold rail.

### DETAILED DESCRIPTION

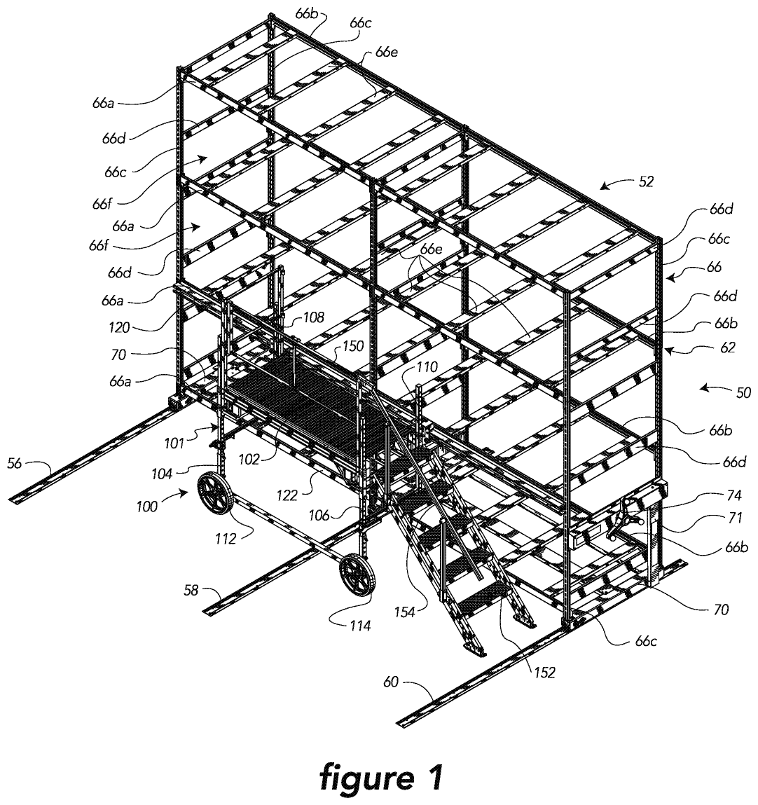

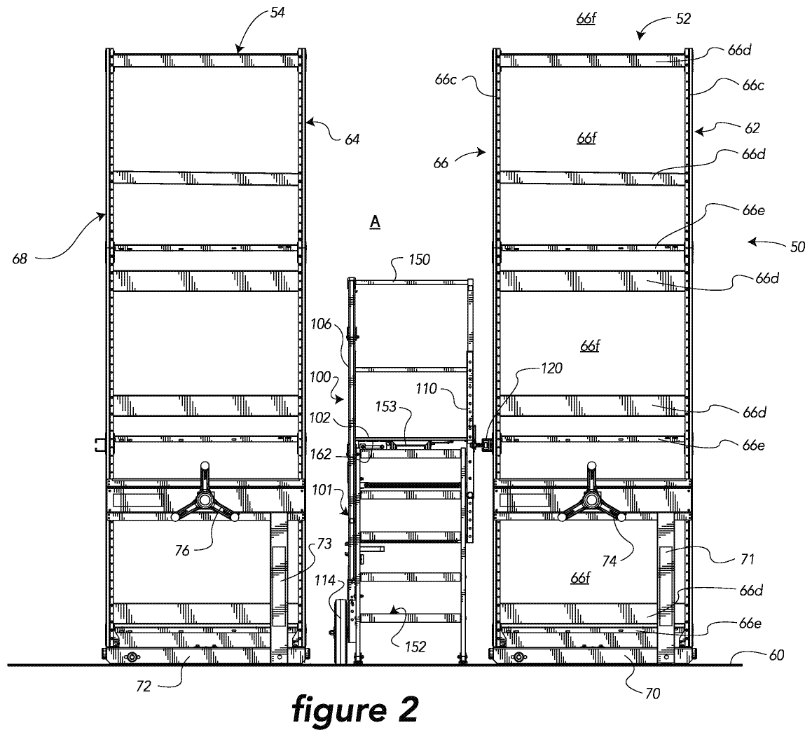

FIGS. 1 and 2 show a racking system 50 that comprises two racks 52, 54 carried on rails 56, 58, 60 that are fixed to the ground, with only one rack 52 being shown in FIG. 1 to avoid concealing other elements of the drawing. Additional racks (not shown) are normally provided in racking system 50 and carried on rails 56, 58, 60. Racks 52, 54 and rails 56, 58, 60 are of known construction.

Racks 52, 54 comprise respective rack frames 62, 64 in the form of trusses that are composed of a number of interlinked beams generally referred to with reference number 66 for rack 52 and 68 for rack 54.

Each rack frame 62, 64 is identical, and rack frame 64 will hereafter be described. Beams 66 of rack frame 64 include horizontal beams 66a, 66b that are horizontally disposed by pairs to serve as supports for transverse supports 66e to receive containers such as e.g. boxes, article or plant trays (not shown). Alternately, shelf platforms (not shown) may be installed on shelf supports 66e and/or on horizontal beams 66a, 66b. Generally, depending on the type of articles or environments they are used in, racks 52, 54 may be used as storage racks to store articles, or as grow racks or cultivation racks if they are used to carry plants that are being grown in interior environments. Articles or plants are located in the shelf area 66f located above each horizontal set of horizontal beams 66a, 66b and supports 66e, including above the topmost set of horizontal beams 66a, 66b and supports 66e.

Beams 66 also include vertical beams 66c that carry horizontal beams 66a, 66b; and reinforcement beams 66d.

Racks 52, 54 are movable along rails 56, 58, 60 by means of respective carriages 70, 72 that include support wheels (concealed in FIGS. 1-2) and drive wheels (also concealed in FIGS. 1-2) that engage rails 56, 58, 60 and that are operatively connected to actuation mechanisms (concealed in FIGS. 1-2) that include suitable rack-and-gear and/or gear-and-chain mechanisms (concealed in FIG. 1-2), partly contained in transmission boxes 71, 73, such that the drive wheels are operatively connected to rotatable handles 74, 76. Different actuation mechanisms including electric motors could alternately be used, as known in the art.

Other equipment (not shown) normally provided on racking systems may further be provided on racking system 50 such as aisle security systems, braking systems, etc . . . .

In use, users may move racks 52, 54 along rails 56, 58, 60 to horizontally stack a number of racks, while leaving a space between two consecutive racks as shown between racks 52, 54 of FIG. 2 to form an aisle A therebetween. It is consequently possible, in a well-known manner, to optimize with such a system the floor space of a storage facility by avoiding aisles being present between each two consecutive racks to instead have a single aisle formed in a group composed of several racks mounted on rails 56, 58, 60. The racks become horizontally stacked against each other, except where the aisle A is formed.

Users may enter aisle A to store and retrieve articles along racks 52, 54 and more particularly in shelf areas 66f. However, one challenge in such a rack arrangement is for the users to access the top shelves when the racks are of a height above human height—which is usually the case.

According to the present invention, and as shown in FIGS. 1-4, racking system 50 is provided with a mobile scaffold 100, for use on one side of a storage rack such as storage rack 52, such that it is usable in an aisle A as that shown in FIG. 2, to access the upper shelf areas 66f of storage racks 52, 54 located on either side of aisle A.

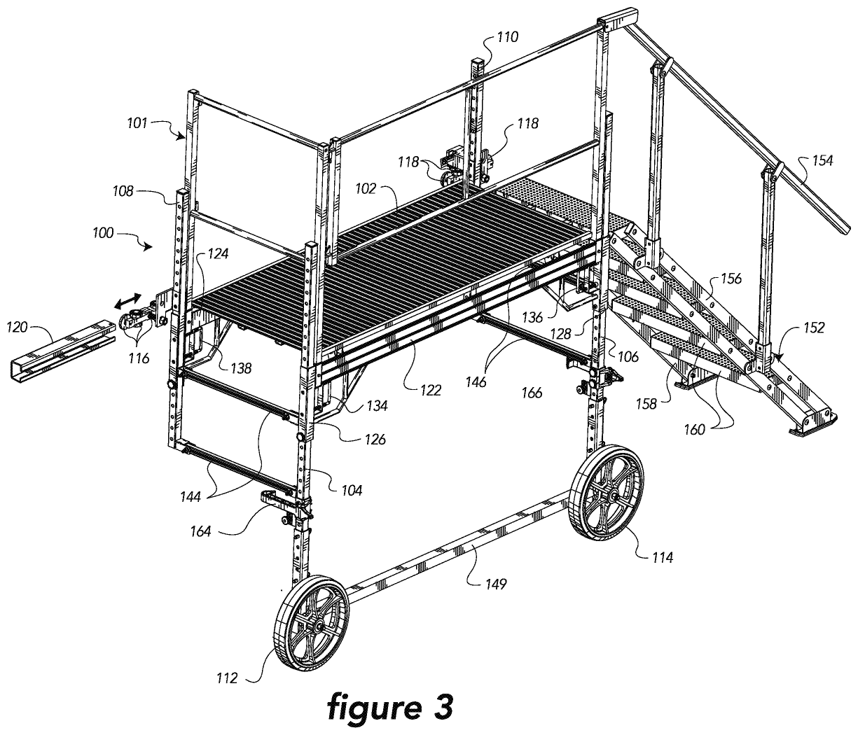

FIGS. 1-4 show that mobile scaffold 100 comprises a platform 102 carried by a scaffold frame 101. Scaffold frame 101 comprises two ground-engaging posts 104, 106 and two rack-engaging posts 108, 110. Ground-engaging posts 104, 106 are equipped with a support member in the form of ground-engaging wheel 112, 114 to allow one side of scaffold 100 to rest on the ground. Rack-engaging posts 108, 110 are equipped with a scaffold guide member in the form of guide wheels 116, 118 that engage and are supported by a rack guide member in the form of a rail 120 that is disposed horizontally on and is fixedly attached to rack frame 62 of rack 52. Guide wheels 116, 118 include wheels that have a horizontal axis and wheels that have a vertical axis since the load of scaffold 100 imparts forces with a vertical vectorial orientation under the gravity but also horizontal vectorial orientation toward and away from rack frame 62. Brackets 122, 124 attach and link guide wheels 116, 118 to posts 108, 110 and extend through the longitudinal side opening of rail 120 that is of a C-shape configuration. As suggested in FIG. 3, guide wheels 116, 118 of scaffold 100 may engage rail 120 by inserting guide wheels 116 of post 108 and then guide wheels 118 of post 110 into the open end of rail 120; and inversely, guide wheels 116, 118 of scaffold 100 may disengage from rail 120 by rolling guide wheels 118 of post 110 and then guide wheels 116 of post 108 out of the open end of rail 120.

A brake 121 is carried by scaffold frame 101, and more particularly by post 110. Brake 121, when activated by a user, may engage rail 120 with a high-friction braking pad (e.g., made of rubber) that will prevent scaffold 100 from moving along rail 120, thereby setting the position of scaffold 100 along rail 120. Brake 121, when deactivated by a user, may disengage rail 120 and allow scaffold 100 to move along rail 120 once again.

The brake could instead act on another component of racking system 50, such that it could act on either one of the scaffold guide member (e.g., guide wheels 116, 118), the rack guide member (e.g., rail 120) and the rack 52 itself, for releasably fixing the position of scaffold 100 relative to rack 52.

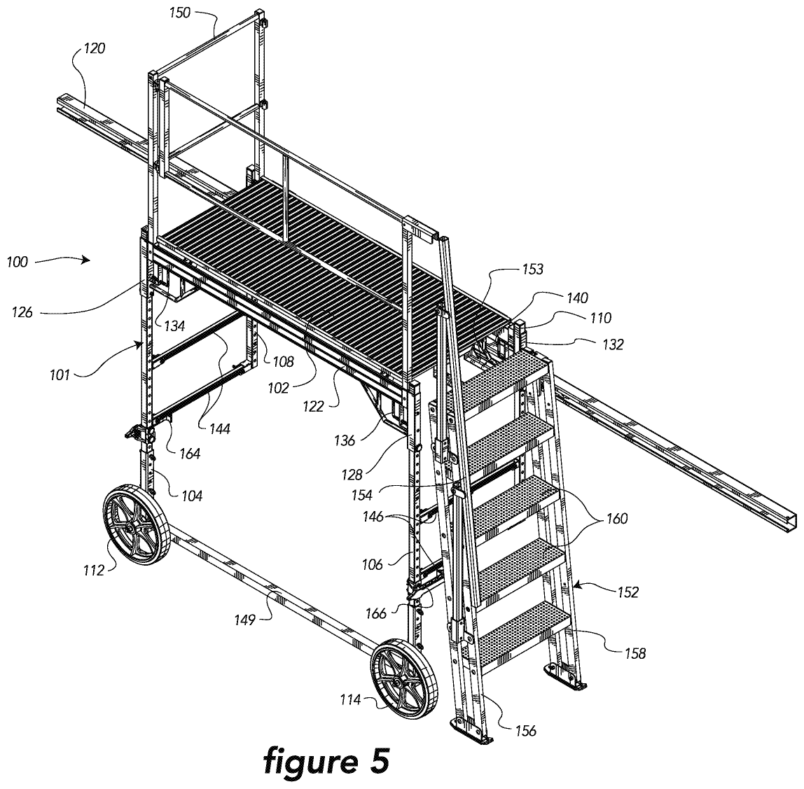

Platform 102 is carried by a pair of longitudinal beams 122, 124 that are each fixedly attached to a pair of respective sleeves 126, 128 (for beam 122) and 130, 132 (for beam 124) at their extremities. Sleeves 126, 128, 130, 132 are each engaged by and slidable along a respective one of posts 104, 106, 108, 110 of frame 101 such that longitudinal beams 122, 124, and consequently platform 102, are vertically movable along posts 104, 106, 108, 110. U-shaped spring-loaded releasable latches 134, 136, 138, 140 are installed on sleeves 126, 128, 130, 132. The free extremities of latches 134, 136, 138, 140 extend through sleeves 126, 128, 130, 132 and through selected holes along the length of posts 104, 106, 108, 110 to releasably set the position of sleeves 126, 128, 130, 132 along posts 104, 106, 108, 110. FIGS. 1-4 show a first exemplary position of sleeves 126, 128, 130, 132 along posts 104, 106, 108, 110 that correspond to a first exemplary height of platform 102, while FIG. 5 shows a second exemplary position of sleeves 126, 128, 130, 132 along posts 104, 106, 108, 110 that correspond to a second exemplary height of platform 102. As a result, frame 101 comprises a height adjustment member in the form of the sleeves 126, 128, 30, 132 that slide along posts 104, 106, 108, 110, with their position being set by latches 134, 136, 138, 140, for adjusting the height of platform 102 relative to guide wheels 116, 118 and to ground wheels 112, 114, and consequently, relative to the ground and to rack 52.

Frame 101 comprises two pairs of transverse reinforcement rods 144 and 146 that respectively link posts 104 and 108 and posts 106 and 110. Sleeves 126, 128, 130, 132 are C-shaped in cross-section to allow sliding along posts 104, 106, 108, 110 without rods 144, 146 interfering. Reinforcement rods 144, 146 are pivotally attached to posts 104, 106, 108, 110, for reasons explained hereinbelow.

Frame 101 comprises a longitudinal reinforcement rod 149 that horizontally extends between posts 104, 106 at the level of wheels 112, 114.

A security fence 150 is attached to, and upwardly projects from, longitudinal beams 122, 124. Fence 150 is optional. Fence 150 can have any suitable shape or size. In the embodiment shown in the drawings, fence 150 projects above two of the four sides of rectangular platform 102.

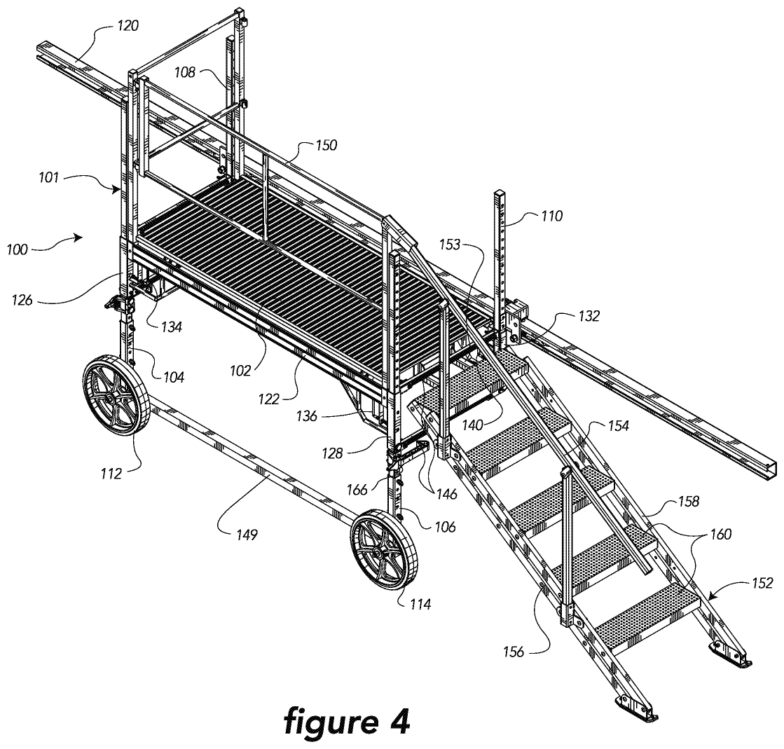

Stairs 152 are removably attached to platform 102 by means of a stair bracket 153. A ramp 154 is fixed to stairs 152. Stairs 152 include pivotable linkages 156, 158 on each side thereof, and ramp 154 is pivotally attached to linkages 156, 158, such that stairs 152 and ramp 154 may be set at different angles to accommodate different heights of platform 102 as shown in FIGS. 4 and 5. The steps 160 of stairs 152 remain horizontal at any inclination of stairs 152, by their pivotal engagement to linkages 156, 158. Stairs 152 are optional; or, if they are used, they could have different configurations to allow access to and egress from platform 102. For example, a ladder could be used to access platform 102, instead.

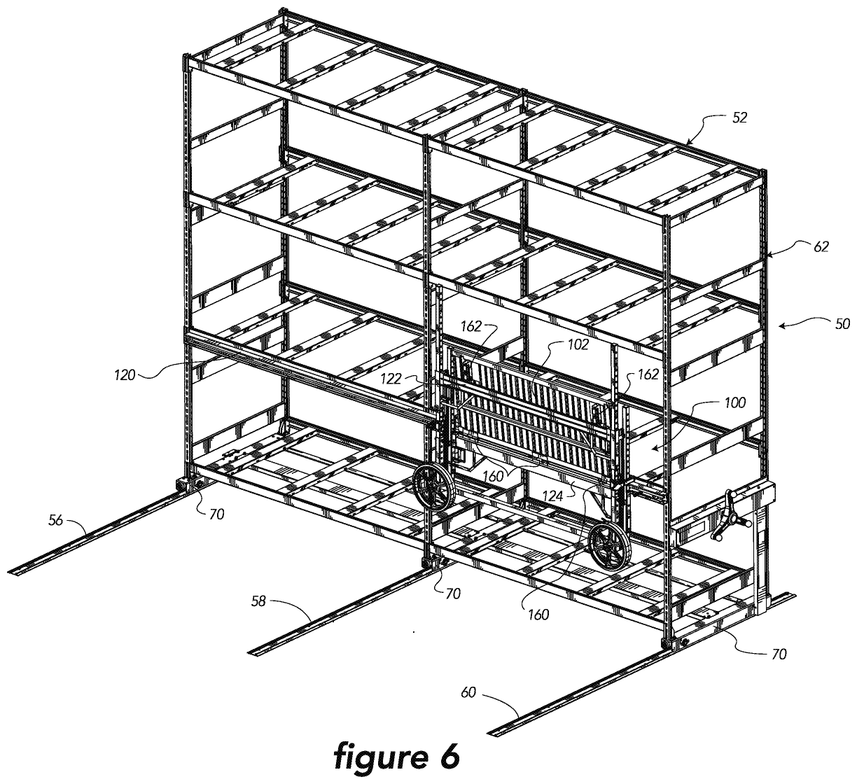

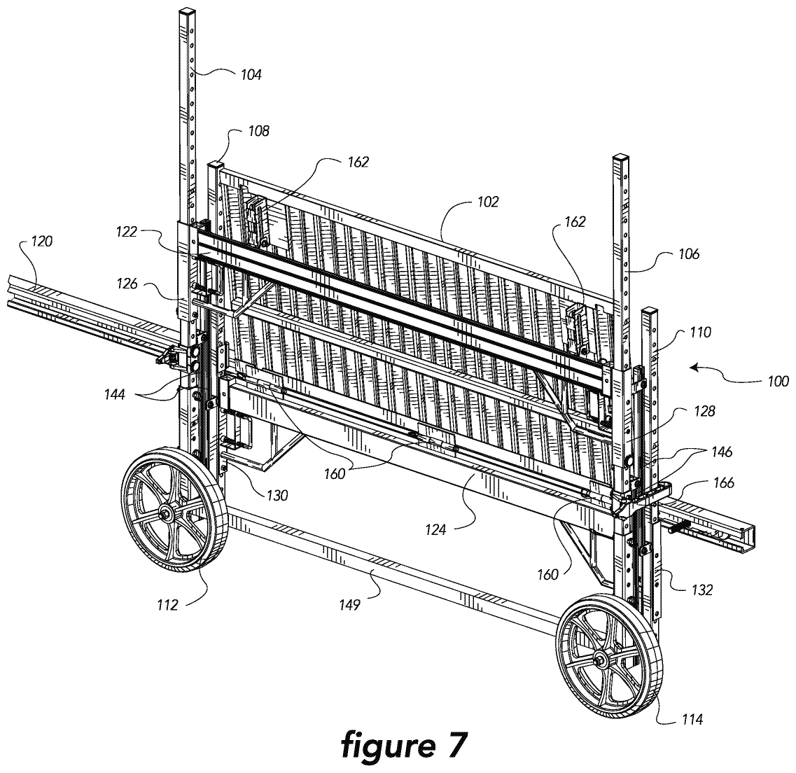

FIGS. 6 and 7 show that mobile scaffold 100 may be folded against rack 52 in a stored position. More particularly, platform 102 is pivotally attached to longitudinal beam 124 by means of a trio of hinges 160 such that platform 102 may pivot about the longitudinal beam 124 located nearest rack 52. To move scaffold 100 from its operative position shown in FIGS. 1-5 to its stored position shown in FIGS. 6-7, stairs 152 are removed and platform 102 is simply pushed upwardly. It will pivot about hinges 106 from a horizontal position to reach an upright position where it is essentially parallel to rack 52. As mentioned above, reinforcement rods 144, 146 are pivotally attached to posts 104, 106, 108, 110 which allows posts 104, 106, 108, 110 to remain parallel but to pivot closer to each other. Platform 102 is also pivotally attached to longitudinal beam 122 which is furthest from rack 52, by means of a pair of sliding hinge members 162 that allow platform 102 to both pivot and slide a limited distance relative to longitudinal beam 122 to adopt its upright position. Once platform 102 is in its upright position, the hooked free extremities of a pair of clasps 164, 166 carried by ground posts 104, 106 will resiliently snap onto rack posts 108, 110 to maintain scaffold 100 in its stored position, with platform 102 in its upright position.

Scaffold 100 may be moved from its stored position back into its operative position by manually forcing clasps 164, 166 so that they resiliently yield and release from their hooked engagement on rack posts 108, 110. Then, under gravity, platform 102 will pivot about hinges 160 from its upright towards its operative position, at which point wheels 112, 114 will rest on the ground. Sliding hinge members 162 will both slide and pivot to allow this displacement.

Scaffold 100 is consequently movable between an operative position in which frame 101 and platform 102 are deployed away from rack 52, in which platform 102 is generally horizontal for supporting a person above ground and in which ground wheels 112, 114 rests on the ground; and a stored position in which frame 101 and platform 102 are moved closer to rack 52 compared to the operative position such that scaffold 100 occupies less horizontal space in aisle A, and in which ground wheel 112, 114 are raised above ground such that the load of scaffold 100 is entirely supported by rack 52.

In one embodiment (not shown), scaffold rails such as rail 120 could be provided on one or both sides of each rack of the racking system 50, to correspondingly allow installation of scaffold 100 wherever a rail 134 is installed. Moreover, more than one rail could be provided on the rack at different heights, to allow usage of scaffold 100 at different heights also.

It can consequently be understood that mobile scaffold 100 may be installed and moved along aisle A by simply inserting guide wheels 116, 118 through the open end of the cross-sectionally C-shaped rail 120; and may be removed from aisle A by sliding guide wheels 116, 118 out of rail 120.

While guide wheels 116, 118 are installed within rail 120, both rack posts 108, 110 are supported by the rail 120 and, incidentally, by a single adjacent rack 52 of racking system 50. Concurrently, ground posts 104, 106 are supported on the ground with wheels 112, 114, such that scaffold 100 is supported on both sides.

While thusly engaged on adjacent rack 52, scaffold 100 may be rolled along rail 120 until a desired position is reached within aisle A. There the user may climb to stand atop platform 102 to access upper the upper shelf areas 66f of either of the two racks 52, 54 located on either side of scaffold 100. Once the user is done accessing those shelf areas 66f, they may climb down from platform 102. Stairs 152 may be used to facilitate access to, and egress from, platform 102.

Scaffold 100 may then either remain in the aisle A where it was last used; moved to another position in aisle A for further use at that new position; removed from aisle A; or pivoted into its stored position, either within aisle A while still attached to rack 54, or outside of aisle A at a desired storage location.

The support of scaffold 100 on a single side to a single rack 52 provides a vertical support for scaffold while it is in its operative position, but also provides a lateral support to prevent scaffold 100 from toppling over. The support on the ground by means of wheels 112, 114 of course supports and stabilizes the scaffold 100, but also, allows the scaffold 100 to be used in aisles having varying widths, as long as that width is at least equal to the width of the scaffold 100.

Also, by being attached to a single rack 52 on one side of aisle A, scaffold 100 allows passage of other persons between the scaffold 100 and the other rack 54 if the width of the aisle A allows it. It does not block the entire width of aisle A, as can be seen in FIG. 2.

An additional advantage of scaffold 100 exists through its stored configuration described above. By having scaffold 100 attached to a single rack 52, it may be folded into its stored position while it remains attached to a rack 52, therefore freeing the aisle A for users to circulate therein. Scaffold 100 remains readily available within aisle A and is easily accessible. This also prevents having to have an actual offsite storage location for storing scaffold 100 while it is not in use within an aisle A.

Scaffold 100 may still be moved along rail 120 in aisle A while it is in its stored position. This allows access to articles in shelf areas 66f that are located behind scaffold 100.

Yet another advantage of scaffold 100 is that multiple scaffold rails such as rail 120 may be attached to each rack 52, 54, . . . of racking system 50, while a single mobile scaffold 100 may then be used in any aisle formed between those racks on a selected one of those multiple rails. After the initial installation of the scaffold rails, no further installation is required by the users. They may displace the mobile scaffold 100 at any location within the aisles, and install it on any desired scaffold rail in that aisle. Furthermore, the permanent installation of the scaffold rails on the racks avoids having to transport installation equipment, which is time-consuming and has unfortunate security issues both in manipulation and in storage.

A further advantage of scaffold 100 of the present invention is that it may be used in an aisle where there is a single rack on one side, and a wall or—more generally—no rack on the other side. It does not require attachment to racks on both sides of the aisle, nor of a support structure on the side opposite the rack that scaffold 100 is attached to. The present invention is particularly, although not exclusively, useful in the case of grow racks or cultivation racks, as users need to intervene regularly on the different shelves where plants are being grown in an interior environment, to tend to said plants in a known manner. Having a scaffold 100 that is easy and quick to displace, within an aisle and between aisles, and that generally has the flexibility in installation and use as described above, is an important advantage in such an environment.

Yet another advantage of the racking system 50 of the present invention is that scaffold 100 may be rolled along the rack 52 to which it is linked, without the user having to climb down. This is allowed by the engagement of guide wheels 116, 118 into rail 120, which prevents the scaffold from toppling over, or from rolling away from rack 52. It remains stable by means of this engagement. The person standing on platform 102 may consequently interact with the top shelf areas 66f all along the aisle A, without having to climb down.

In one embodiment (not shown), the transformation of scaffold 100 from its operative to its stored position may be different. For example, the platform could fold along a central axis along the platform with hinges being provided along that central axis.

Generally, according to the present invention, scaffold 100 is advantageously used in a racking system 50 comprising multiple racks, and particularly mobile racks, but it is not limited thereto, and could be used in a racking system having fixed racks, or a single fixed or mobile rack.

Scaffold 100 defines a frame 101 as described above, that in turn defines opposite first and second sides: one side is equipped with a rack support member in the form of the guide wheels 116, 118 that are carried by frame 101 for allowing releasable engagement of frame 101 to rack 52. Frame 101 comprises a second support member that may be in the form of ground wheels 112, 114 for support on the ground as described above, but, in an alternate embodiment (not shown), frame 101 could instead be supported on the ground with a different ground support member such as support feet that slide on the ground; or, in yet another embodiment (not shown), the second support member could engage the rack 52 itself instead of the ground, for example along a bottom rail that would be installed near the ground on the rack frame 62, spaced from the rail 120. In all embodiments, frame 101 is linked to a single rack 52 of racking system 50.

In one embodiment (not shown), a different scaffold guide member is used on scaffold 100 instead of guide wheels 116, 118, which engages a complementary rack guide member which could also differ from rail 120. It is understood that the intent of the complementary scaffold guide member and rack guide member is to allow the releasable engagement of frame 102 to rack 52 such that frame 101 is retained against rack, is guided along said rack 52 and may move along rack 52. For instance, frame 101 could engage rack 52 with a suitable slider member that would slidingly engage rail 120.

In one embodiment (not shown), the ground wheels 112, 114 could be replaced with slidable ground-engaging members or with universal ball-wheels allowing scaffold 100 to roll or slide in any direction. This would allow scaffold 100 to follow the rack 52 to which it is linked as rack 52 is moved along ground rails 56, 58, 60.

In one embodiment (not shown), the scaffold frame posts 108, 110 that are closest to rack 52 are also provided with ground-engaging supports. In such a case, the guide wheels 116, 118 then have only a guiding purpose and do not support the load of scaffold 100 that would be entirely supported by the four ground wheels.

Scaffold 100 is generally movable between an operative position in which frame 101 and platform 102 are deployed away from rack 52 and in which platform 102 is generally horizontal for supporting a person above ground, and a stored position in which frame 101 and platform 102 are moved closer, e.g., pivoted or folded against, rack 52 compared to the operative position so as to occupy less horizontal spaced in aisle A.

The height of platform 102 relative to the rack support member (guide wheels 116, 118) and to the ground-engaging support member (ground wheels 114, 116) has been disclosed above as comprising telescopic posts 104, 106, 108, 110, but any other height adjustment (not shown) could also be envisioned.

What is claimed is:

1. A mobile scaffold for a racking system of a type comprising at least one rack, said scaffold comprising:
a frame defining opposite first and second sides;
a platform carried by said frame, for supporting a person above ground;
a scaffold guide member carried by said frame on said first side for allowing releasable engagement of said frame to a complementary rack guide member on the rack such that said frame is retained against said rack, is guided along said rack and is movable along said rack; and
a support member carried by said frame for allowing releasable support of said frame by either one of said rack and the ground;
wherein said frame is linked only to said at least one rack and to no other rack of said racking system.

2. A scaffold as defined in claim 1, wherein said second member comprises a ground-engaging support member carried by said frame for resting on the ground.

3. A scaffold as defined in claim 2, wherein said ground-engaging member comprises ground-engaging wheels that are located on said second side of said frame.

4. A scaffold as defined in claim 2, wherein said scaffold guide member comprises guide wheels for engagement into a rail forming said rack guide member carried by said rack.

5. A scaffold as defined in claim 2, wherein said scaffold guide member further allows the scaffold to be partly supported by said rack, such that said scaffold guide member and said ground-engaging support member share a load of said scaffold.

6. A scaffold as defined in claim 5, wherein said scaffold is movable between an operative position in which said platform is generally horizontal for supporting the person above ground and in which said support member rests on the ground, and a stored position in which said frame and said platform are moved away from said operative position into a compact configuration that occupies less horizontal space than said operative position, and in which said support member is raised above ground such that the load of said scaffold is entirely supported by the rack.

7. A scaffold as defined in claim 6, wherein said platform is pivotally mounted to said frame and is pivotable between said operative and stored positions.

8. A scaffold as defined in claim 1, wherein said frame comprises a height adjustment member for adjusting the height of the platform relative to said rack support member and to a ground-engaging support member.

9. A scaffold as defined in claim 1, wherein said frame further carries a brake that is releasably engageable with either one of the scaffold guide member, the rack guide member and the rack, for releasably fixing a position of said scaffold relative to the rack.

10. A racking system comprising at least one rack and a mobile scaffold, said scaffold comprising:
a frame defining opposite first and second sides;
a platform carried by said frame, for supporting a person above ground;
a scaffold guide member carried by said frame on said first side;
a rack guide member carried by said rack which is complementary to said scaffold guide member, with said scaffold guide member releasably engaging said rack guide member such that said scaffold is retained against said rack and is guided along said rack while allowing said scaffold to be movable along said rack; and
a support member carried by said frame for allowing releasable support of said frame by either one of said rack and the ground;
wherein said frame is linked to a single rack of said racking system.

11. A racking system as defined in claim 10, wherein said support member comprises a ground-engaging support member carried by said frame for resting on the ground.

12. A racking system as defined in claim 10, wherein said scaffold guide member comprises guide wheels, and said rack guide member comprises a rail.

13. A racking system as defined in claim 11, wherein said scaffold guide member further allows a load of said scaffold to be partly supported by said rack, such that said scaffold guide member and said ground-engaging support member share the load of said scaffold.

14. A racking system as defined in claim 13, wherein said scaffold is movable between an operative position in which said frame and said platform are deployed away from said rack, in which said platform is generally horizontal for supporting the person above ground and in which said support member rests on the ground, and a stored position in which said frame and said platform are moved closer to said rack compared to said operative position such that said scaffold occupies less horizontal space, and in which said support member is raised above ground such that the load of said scaffold is entirely supported by the rack.

15. A racking system as defined in claim 14, wherein said platform is pivotally mounted to said frame and is pivotable between said operative and stored positions.

16. A racking system as defined in claim 10, wherein said frame comprises a height adjustment member for adjusting the height of the platform relative to said rack support member and a ground-engaging support member.

17. A scaffold as defined in claim 10, wherein said frame further carries a brake that is releasably engageable with either one of the scaffold guide member, the rack guide member and the rack, for releasably fixing a position of said scaffold relative to the rack.
